(19) United States
(12) Patent Application Publication
(10) Pub. No.: US 2006/0059044 A1
(43) Pub. Date: Mar. 16, 2006

(54) Method and system to provide advertisements based on wireless access points

(76) Inventors: Wesley T. Chan, Mountain View, CA (US); Shioupyn Shen, Mountain View, CA (US); Georges Harik, Mountain View, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 10/941,431

(22) Filed: Sep. 14, 2004

(51) Int. Cl. G06Q 30/00

(52) U.S. Cl. 705/14

(57) ABSTRACT

Methods and system to provide advertisements in a view of an end user accessing a wireless access point. The advertisements are related to the WAP based on a predetermined criterion.

### FIELD OF INVENTION

The field of invention relates generally to wireless data communication, and more particularly, to provide advertisements based on wireless access points.

### BACKGROUND

Mobile computer users are able to enjoy wireless Internet access at various wireless access points (WAPs), commonly referred to as WiFi access points. The WiFi access points are wireless access points that are compatible with IEEE 802.11, as certified by the Wireless Fidelity (WiFi) Alliance.

Typically, WiFi operators deploy WiFi access points at high traffic locations to meet the need of mobile users. The cost of WiFi deployment, however, is relatively high and WiFi operators charge their customers accordingly to recoup their investment and make some profits.

In particular, much of the expense in providing WiFi access is related to setting up the infrastructure to charge for the wireless Internet access. For example, a WiFi provider typically needs to maintain user accounts, user authorizations, usage metering, billing, support, and maintenance. In addition, expenses further include the monthly cost of connecting the access points to Internet, powering them, hosting them, and servicing them as well.

The relative high price for an end-user to access a WiFi access point is typically not a problem for executives or road warriors. However, many casual mobile computer users may be deterred from using WiFi Internet access because they typically only need it once in a while and are reluctant to pay a premium price for their occasional needs.

As a result, the gap between what WiFi operators charge and what casual mobile users are typically willing to pay, is relatively significant. Therefore, WiFi Internet access as an industry has experienced a rather slow start.

Thus, what is desired is a method or system that helps overcome one or more of the above-described limitations.

### SUMMARY

In one embodiment, advertisements are placed in a view of an end user accessing a wireless access point. The advertisements are related to the WAP based on a predetermined criterion.

### BRIEF DESCRIPTION OF THE DRAWINGS

FIG. 1 presents a flow diagram describing the process to provide advertisements based on WAPs, in accordance with one embodiment.

FIG. 2 presents a flow diagram describing the process to provide advertisements based on geographical location of WAPs, in accordance with one embodiment.

FIG. 3 presents a flow diagram describing the process to provide advertisements based on an operation/subject matter of an entity providing the WAP, in accordance with one embodiment.

FIG. 4 presents a flow diagram describing the process of providing traffic from a WAP through a first entity, in accordance with one embodiment.

FIG. 5 presents a system architecture diagram, in accordance with one embodiment.

FIG. 6 presents a flow diagram describing the process to provide access to WAPs at a reduced rate, in accordance with one embodiment.

FIG. 7 illustrates an exemplary implementation, in accordance with one embodiment.

### DETAILED DESCRIPTION

### OVERVIEW OF ONE EMBODIMENT

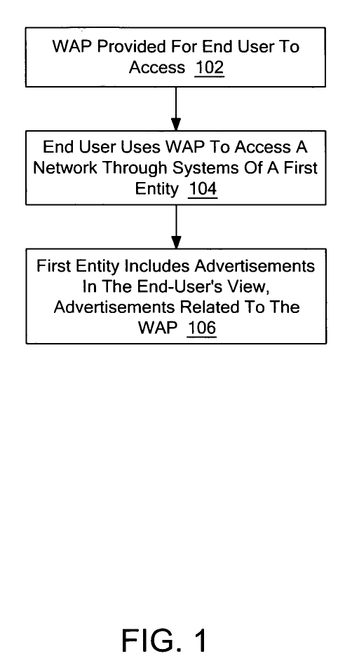

A method and system to provide advertisements based on wireless access points, is described. FIG. 1 presents a flow diagram describing the process to provide advertisements based on WAPs, in accordance with one embodiment. As illustrated, in stage 102 a WAP operator (also referenced herein as a WiFi provider or operator), provides a wireless access point for end-users to access.

In stage 104, an end-user uses the WAP to access a network by passing through systems of a first entity, which provide a gateway to the destination network. In one embodiment, the destination network may be the Internet. In alternative embodiments, networks other than the network may be accessed.

In stage 106, the first entity places advertisements in the end-user's view. The advertisements are related to the WAP based on predetermined criteria. In one embodiment, the advertisements provided in the end user view by the first entity, are based on a geographical location of the WAP. For example, the advertisements may include advertisements for stores, services, business, etc. that are relatively local to the geographical location of the WAP.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Description of Process To Provide Advertisements Based on WAPs

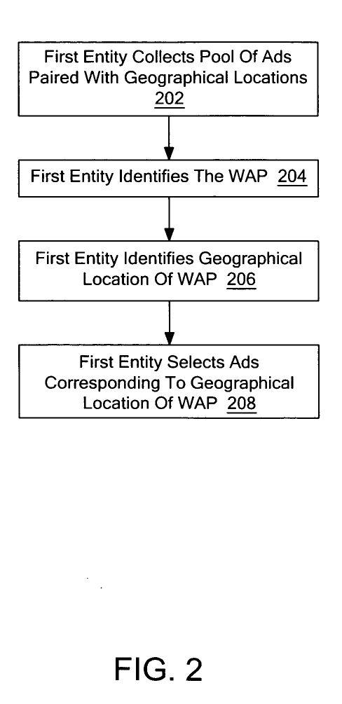

FIG. 2 presents a flow diagram describing the process to provide advertisements based on geographical location of WAPs, in accordance with one embodiment. In stage 202, the first entity may collect a pool of advertisements. One or more of the advertisements correspond to one or more geographical locations. In stage 204, when an end user of a WAP accesses a network through the gateway of the first entity, the first entity may use part of the Internet Protocol (IP) address to identify the respective WAP. Alternative techniques may also be used to determine an identity of a WAP.

In stage 206, the first entity uses the identity of the respective WAP to determine a geographical location corresponding to the WAP. In one embodiment, the first entity may have a storage unit that pairs WAPs to one or more geographical locations. In stage 208, the first entity proceeds to select advertisements corresponding to the geographical location of the WAP accessed by the end user.

In one embodiment the first entity selects advertisements geographically related to the respective WAP based on additional predetermined criteria. For example, advertisements geographically related within a predetermined distance of the respective WAP may be selected to be included in the end user's view.

In another embodiment, the advertisements provided in the end user view by the first entity, may be related to an operation/subject matter of an entity providing a WAP. For example, the entity providing the WAP may be a travel service providing the WAP in an airport. As a result, the advertisements may include advertisements related to travel.

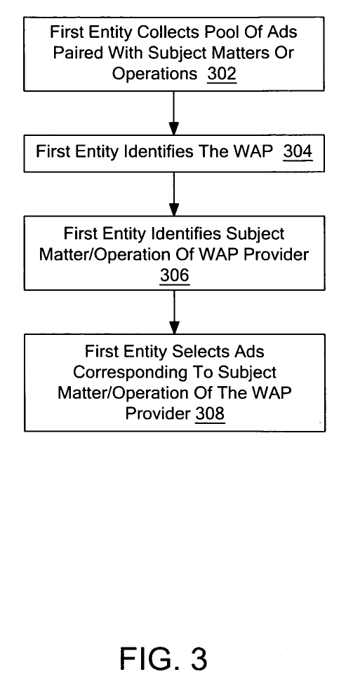

FIG. 3 presents a flow diagram describing the process to provide advertisements based on an operation/subject matter of an entity providing the WAP, in accordance with one embodiment. In stage 302, the first entity may collect a pool of advertisements. One or more of the advertisements correspond to one or more subject matters or operations.

In stage 304, the first entity may again identify the respective WAP used by an end user via part of the IP address, as described above. In stage 306, the first entity uses the identity of the respective WAP to determine an operation or subject matter corresponding to an entity providing the WAP. As described above, in one embodiment, the first entity may have a storage unit that pairs WAPs to one or more operations or subject matters.

In stage 308, the first entity proceeds to select advertisements corresponding to the operations or subject matter of the entity providing the WAP, to be included in a view presented to an end user.

In another embodiment, the advertisements provided in the end user view by the first entity, may be pre-selected by an entity (or another) providing the WAP, or another. For example, the entity providing the WAP may want to include advertisements related to a particular cause, message, etc. As a result, advertisements related to such are pre-identified by the entity providing the respective WAP. The preselected advertisements/messages are placed in the view of the end-user, in accordance with the processes discussed above.

In another embodiment, the advertisements provided in the end user view by the first entity, may be based at least in part on profile of the respective WAP. The first entity, or another, may monitor advertisements and/or activities of end users of the WAP to generate a profile for the WAP. The profiles may be periodically generated or continuously dynamically generated.

In one embodiment, the profiles of the WAPs may be based multiple items that characterize a users' preferences. These items may be extracted from various information sources, including previous search queries submitted by the users, types of advertisements selected and frequency, links from or to the documents identified by the previous queries, sampled content from the identified documents as well as personal information implicitly or explicitly provided by the user.

More specifically, in one embodiment the user profiles/behavior can be derived in a number of ways. First, a user can select certain “preference” parameters manually on a browser, toolbar, or other network interface which can then be used to bias search results and/or advertisements to the user. Second, a cookie can track user behavior, like what queries they enter, what results they click on, how long they stay on particular pages, etc. And third, a toolbar (sometimes called a “navclient”) may be used to track navigation of a particular user. Other techniques may also be used.

As stated above, the profile of the WAPs may be used by the first entity to determine the advertisements to include in the respective end users view. For example, in one embodiment, the profiles may be used to determine the advertisements to include in a process similar to the process of using profiles to personalize search results.

In particular, embodiments of processes of using profiles to personalize search results are described in the U.S. patent application entitled Personaliztion of Web Search, filed on Sep. 30, 2003, assigned Ser. No. 10/676,711, and U.S. patent application entitled Personaliztion of Placed Content Ordering In Search Results, filed on Jul. 13, 2004, assigned Ser. No. 10/890,854, both of which are incorporated herein by reference.

In one embodiment, when the search engine receives a search query from a user, it may identify a set of documents that match the search query. Each document is associated with a generic rank based on the document's page rank, the text associated with the document, and the search query. The search engine also identifies the user's profile and correlates the user profile with each of the identified documents. The correlation between a document and the user profile produces a profile rank for the document, indicating the relevance of the document to the user. The search engine then combines the document's generic rank and profile rank into a personalized rank. Finally, the documents are ordered according to their personalized ranks.

In one embodiment, a user profile may comprise a plurality of sub-profiles, each sub-profile characterizing the user's interest from a different perspective. A term-based profile comprises a plurality of terms, each term carrying a weight indicative of its importance relative to other terms. A category-based profile comprises multiple categories, optionally organized into a hierarchical map. The user's search preferences may be associated with at least a subset of the multiple categories, each category having an associated weight indicating the user's interest in the documents falling into this category. There may be multiple category-based profiles for a user. In some embodiments, the sub-profiles include a link-based profile, which includes a plurality of links that are, directly or indirectly, related to identified documents, each link having a weight indicating the importance of the link. Links in the link-based profile may be further organized with respect to different hosts and domains.

In another embodiment, the advertisements provided in the end user view by the first entity, may be based on a combination of the geographical location of the WAP, the operations of the entity providing the WAP, pre-selected by the entity providing the WAP, a profile of the respective WAP, and/or other factors.

Description of Process to Provide Network Access Through Gateway of First Entity

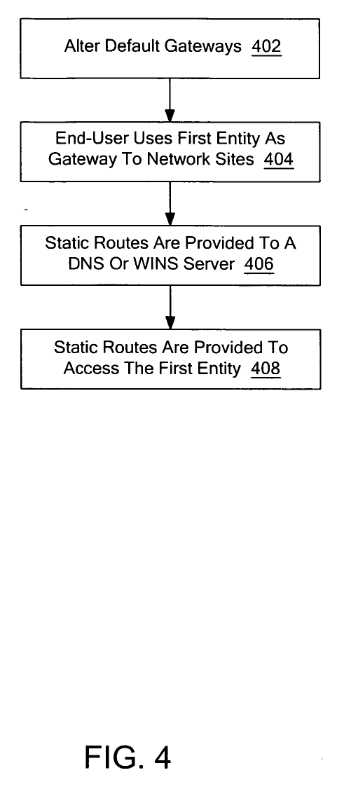

In one embodiment, the WAPs are in effect restricted to tunneling network traffic through the first entity to have the first entity place advertisements in a view presented to an end-user of the respective WAPs. FIG. 4 presents a flow diagram describing the process of providing traffic from a WAP to the first entity, in accordance with one embodiment. In stage 402, the default gateways in the routing tables of a WAP may be altered to block all traffic except those configured in static routes.

To access network sites other than those provided with static routes, in stage 404 the end-user uses the systems of the first entity as a gateway. For example, in one embodiment, the end-user either proxies through, or establishes a virtual packet network (VPN) with the systems of the first entity.

In one embodiment, a client application is loaded onto the end-user system. With the client application the end-user is able to either proxy through or establish a VPN with the first entity to access other network sites.

In stage 406, in one embodiment, static routes are provided to a dynamic name systems (DNS) or Windows Internet name service (WINS) server to allow DNS/WINS queries to go through. And, in stage 408, additional static routes are also provided to the first entity's data centers to allow traffic to the first entity's data centers to go through.

Description of System Architecture

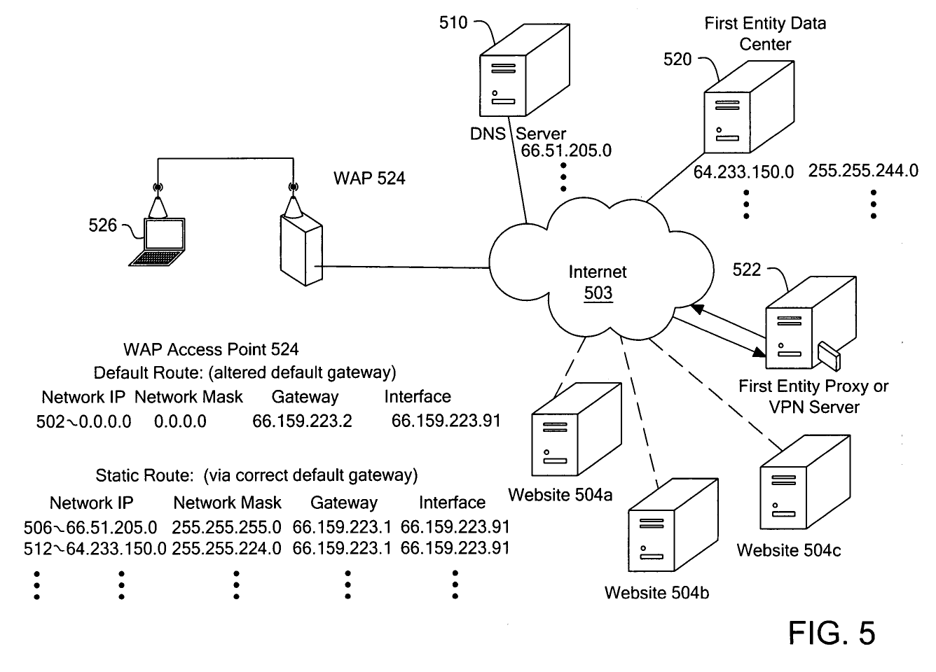

FIG. 5 presents a network diagram illustrating the tunneling of Internet traffic 503 from a WiFi access point 524 through the first entity, in accordance with one embodiment. As illustrated, the default gateway 502 may be altered to block access to other web sites 504a-504c. Static routes 506-508 to a DNS or WINS server 510 may be provided to resolve IP addresses. Static routes 512-518 to the first entity's data centers 520 may also provided for an end-user 526 to reach the first entity without problem.

When an end-user 526 wants to access Internet sites other than those provided with static routes, the end-user 526 may either proxy through, or establishes a virtual packet network (VPN) with the systems 522 of the first entity. As a result, in one embodiment, Internet traffic 503 travels through the first entity prior to an Internet destination.

In alternative embodiments, alternative implementations may be used to tunnel Internet traffic from a WiFi access point through the first entity. For example, some alternative implementations include: having the first entity provide its own WiFi access point; and/or, providing a list of service set identifier-wired equivalent privacy (SSID-WEP) settings to be down loaded by an end-user to connect to any of the listed WiFi access points.

Description of Process to Provide Access to WAP at Reduced Rate

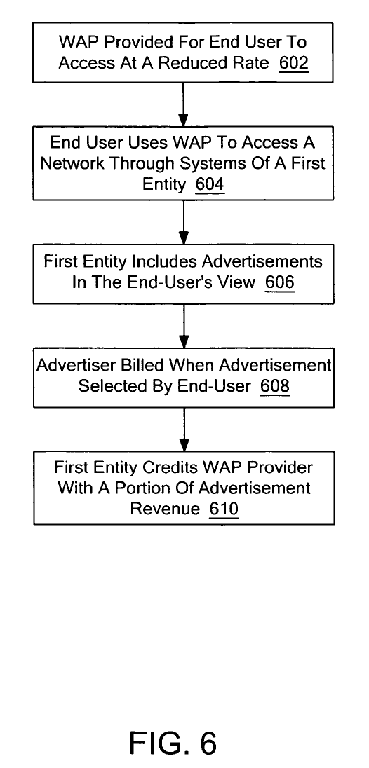

FIG. 6 presents a flow diagram describing the process to provide access to WAPs at a reduced rate, in accordance with one embodiment. As illustrated, in stage 602 a WAP operator provides a wireless access point for end-users to access. In one embodiment, end-users are able use the WAP free of charge to gain access to the Internet or other networks. In alternate, embodiments, the end-users pay a rate to the WAP operator that is reduced relative to a rate typically charged for access to a conventional WAP or WiFi hotspot.

In stage 604, an end-user uses the WAP to access a network by passing through systems of a first entity, which provide a gateway to the destination network. In stage 606, the first entity places advertisements in the end-user's view. In one embodiment, as described above, the advertisements are related to the WAP based on predetermined criteria.

In one embodiment, the advertisements that are included in the end user view may be presented with a hyperlink that when selected by an end-user results in additional information being displayed. In stage 608 when the hyperlink of an advertisement is selected by an end-user, the respective advertiser is billed by the first entity.

In stage 610, the first entity, in turn, credits the WAP provider with a portion of the advertisement revenue. The portion of the revenue may include a flat rate, a percentage of the advertisement revenue, or a combination thereof. In one embodiment, the first entity identifies the WAP to be credited via the IP address.

As a result of receiving a portion of the advertisement revenue, the WAP provider is may cover the expenses of providing the WAP and may recoup a profit, while providing end-users with access to the WAP at a reduced rate.

In alternative embodiments, data other than advertisements could be inserted by the first entity into the view presented to the end-user accessing a WAP. For example, the data could in the form of a message, or a static advertisement that does not include a hyperlink.

Furthermore, the processes and architecture described above may be used to provide wireless access at a reduced rate for multiple WAPs, including multiple disparate WAPs.

Description of Exemplary Implementation

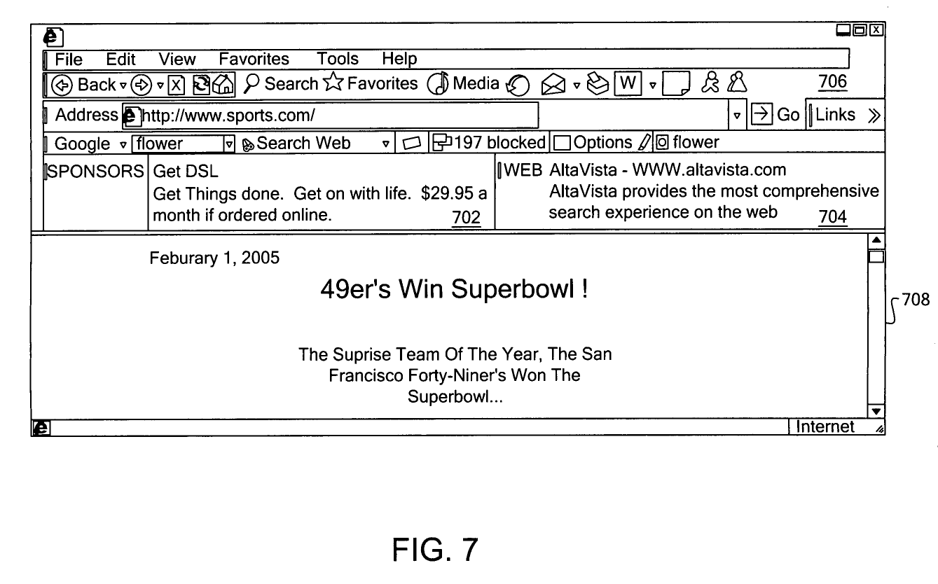

In one embodiment, as illustrated in the example view of FIG. 7, the advertisements 702-704 are provided in a toolbar 706 displayed on an end-user's view 708. The toolbar includes a row or column of on-screen buttons used to activate functions in an application, such as a web browser. In alternative embodiments, the advertisements from the first entity may be placed in alternative locations, such as within (or to the side of) content accessed by, or provided to the end-user.

The advertisements may continue to be served at a pace that is independent of the end user's activity. For example, in one embodiment, the advertisements placed in the end user's view by the first entity, can continue to be refreshed regardless of whether a web page, or other, being viewed is updated. The advertisements may also be served during page transitions.

In addition, the ? that the advertisements are served to the end users, in one embodiment, is independent of the type of network traffic that passes through the gateway of the first entity. For example, is an end user of WAP has accessed the Internet to perform IM activity, the first entity may serve advertisements to the end users to be placed in the end user's tool bar, or web page content down loaded.

General Legal Statements

In one embodiment, the process for selecting the advertisements to be included in the end users view may be based, at least in part, on relevancy to a selected document. In particular, one embodiment of a process of selecting advertisements is described in the U.S. patent application entitled Method and Appartus For Serving Relevant Advertisements, filed on Dec. 6, 2002, assigned Ser. No. 10/314,427, which is incorporated herein by reference.

More specifically, in one implementation, the document is a web page and the advertisements are electronic files that are capable of being rendered on that web page. A set, such as a list, of topics corresponding to the web page is generated by analyzing the content of the web page. There are a variety of techniques by which this may be performed, one of which is by computing a term vector for the web page and selecting the top N terms from that vector. The list of topics is compared to target information associated with the advertisements (e.g., keywords specified for the advertisements) to determine which of the advertisements are relevant to the web page. Some or all of these relevant advertisements may then be associated with the web page so that they may be rendered (e.g., displayed) with the web page.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. For example, the processes as described herein may also be used to bias/personalize web search results, and/or provide suggestions of links that may be of interests. The specification and drawings are, accordingly, to be regarded in an illustrative rather than a restrictive sense.

In addition, the manner in which the advertisements are served to the end users, in one embodiment, is independent of the type of network traffic that passes through the gateway of the first entity. For example, is an end user of WAP has accessed the Internet to perform IM activity, the first entity may serve advertisements to the end users to be placed in the end user's tool bar, or web page content down loaded.

1. A method comprising:
placing advertisements in a view of an end user accessing a wireless access point (WAP), the advertisements being related to the WAP based on a predetermined criterion.

2) The method of claim 1, wherein the advertisements are based on a geographical location of the WAP.

3) The method of claim 1, wherein the advertisements are based on an operation of an entity providing the WAP.

4) The method of claim 1, wherein the advertisements are selected by an entity providing the WAP.

5) The method of claim 1, wherein the advertisements are based on a profile of the WAP.

6) The method of claim 5, wherein the profile is on based on behavior of end users accessing of the respective WAP.

7) A method comprising:
placing advertisements in a view of an end user accessing a wireless access point (WAP), the advertisements being related to the WAP based on one of a geographical location of the WAP, an operation of an entity providing the WAP, selected by the entity providing the WAP, and a profile of the WAP

8) A method comprising:
placing advertisements in a view of an end user accessing a wireless access point (WAP), the advertisements being related to the WAP based a profile of the WAP, wherein the profile is on based on behavior of end users accessing of the respective WAP.

9) An apparatus comprising:
a means for placing advertisements in a view of an end user accessing a wireless access point (WAP), the advertisements being related to the WAP based on a predetermined criterion.

10) A method comprising:
placing advertisements in a view of an end user accessing a wireless access point (WAP), wherein the advertisements are based on a geographical location of the WAP.

11) A method comprising:
placing advertisements in a view of an end user accessing a wireless access point (WAP), wherein the advertisements are based on an operation of an entity providing the WAP.

12) A method comprising:
placing advertisements in a view of an end user accessing a wireless access point (WAP), wherein the advertisements are selected by an entity providing the WAP.

13) A method comprising:
placing advertisements in a view of an end user accessing a wireless access point (WAP), wherein the advertisements are based on a profile of the WAP.

14) An apparatus comprising:
means for placing advertisements in a view of an end user accessing a wireless access point (WAP), wherein the advertisements are based on a geographical location of the WAP.

15) An apparatus comprising:
means for placing advertisements in a view of an end user accessing a wireless access point (WAP), wherein the advertisements are based on an operation of an entity providing the WAP.

16) An apparatus comprising:
means for placing advertisements in a view of an end user accessing a wireless access point (WAP), wherein the advertisements are selected by an entity providing the WAP.

17) An apparatus comprising:
means for placing advertisements in a view of an end user accessing a wireless access point (WAP), wherein the advertisements are based on a profile of the WAP.

18) A machine-readable medium having stored thereon a set of instructions, which when executed, perform a method comprising of:
placing advertisements in a view of an end user accessing a wireless access point (WAP), the advertisements being related to the WAP based on a predetermined criterion.

19) A machine-readable medium having stored thereon a set of instructions, which when executed, perform a method comprising of:
placing advertisements in a view of an end user accessing a wireless access point (WAP), wherein the advertisements are based on a geographical location of the WAP.

20) A machine-readable medium having stored thereon a set of instructions, which when executed, perform a method comprising of:
placing advertisements in a view of an end user accessing a wireless access point (WAP), wherein the advertisements are based on an operation of an entity providing the WAP.

21) A machine-readable medium having stored thereon a set of instructions, which when executed, perform a method comprising of:
placing advertisements in a view of an end user accessing a wireless access point (WAP), wherein the advertisements are selected by an entity providing the WAP.

22) A machine-readable medium having stored thereon a set of instructions, which when executed, perform a method comprising of:
placing advertisements in a view of an end user accessing a wireless access point (WAP), wherein the advertisements are based on a profile of the WAP.

23) An apparatus comprising:
A means for placing advertisements in a view of an end user accessing a wireless access point (WAP), the advertisements being related to the WAP based a profile of the WAP, wherein the profile is on based on behavior of end users accessing of the respective WAP.

24) A machine-readable medium having stored thereon a set of instructions, which when executed, perform a method comprising of:
placing advertisements in a view of an end user accessing a wireless access point (WAP), the advertisements being related to the WAP based a profile of the WAP, wherein the profile is on based on behavior of end users accessing of the respective WAP.
